(19) United States
(12) Patent Application Publication
(10) Pub. No.: US 2015/0214791 A1
(43) Pub. Date: Jul. 30, 2015

(54) STATOR CORE AND SPINDLE MOTOR INCLUDING THE SAME

(71) Applicant: SAMSUNG ELECTRO-MECHANICS CO., LTD., Suwon-Si (KR)

(72) Inventor: A Mi LEE, Suwon-Si (KR)

(73) Assignee: SAMSUNG ELECTRO-MECHANICS CO., LTD., Suwon-Si (KR)

(21) Appl. No.: 14/585,192

(22) Filed: Dec. 30, 2014

(30) Foreign Application Priority Data
Jan. 27, 2014 (KR) 10-2014-0009828

(51) Int. Cl. H02K 1/18

(52) U.S. Cl. CPC H02K 1/187

(57) ABSTRACT

There are provided a stator core and a spindle motor including the same. The stator core includes a core back having a ring shape; a plurality of buffer members adhered to an outer peripheral surface of the core back; and a plurality of teeth parts including a winding part adhered to the plurality of buffer members to protrude in an outer diameter direction of the core back and having a coil wound therearound and a stopper preventing the coil from being separated. Therefore, the buffer member may perform a damping function between the core back and the teeth part, such that vibrations and noise generated at the time of operation of the spindle motor may be decreased.

### CROSS-REFERENCE TO RELATED APPLICATION

This application claims the benefit of Korean Patent Application No. 10-2014-0009828 filed on Jan. 27, 2014, with the Korean Intellectual Property Office, the disclosure of which is incorporated herein by reference.

### BACKGROUND

The present disclosure relates to a stator core and a spindle motor including the same, and more particularly, to a stator core capable of decreasing vibrations and noise, and a spindle motor including the same.

A hard disk drive (HDD), an information storage device, reads data stored in a disk or writes data to a disk using a read/write head.

Such a hard disk drive requires a disk driving device capable of driving the disk. In such a disk driving device, a spindle motor is used.

Further, in a stator core provided in most spindle motors installed in disk drives, electromagnetic force generated by a coil wound around the stator core and a current flowing in the coil is a rotation torque generation source of the spindle motor.

Referring to FIGS. 1 and 2, generally, in a spindle motor 1, a permanent magnet 3 is provided at a rotating rotor 2, and a stator core 5 including a coil 4 wound therearound is provided at a fixed portion.

In the spindle motor 1 as described above, when a current is applied to the coil 4, electromagnetic force is generated, and the rotor 2 rotates due to interaction with the permanent magnet 3 provided adjacently thereto.

Meanwhile, slots 5a and teeth 5b are provided in the stator core 5, in order to allow the coil 4 to be easily wound. In this case, when a current is applied to the coil 4 wound around the teeth 5b, a magnetic field is generated, but since such a magnetic field is may not be uniform, vibrations and noise may be generated when the motor rotates.

### SUMMARY

An aspect of the present disclosure may provide a stator core capable of decreasing vibrations at the time of rotation of a motor and a spindle motor including the same.

According to an aspect of the present disclosure, a stator core may include: a core back having a ring shape; a plurality of buffer members adhered to an outer peripheral surface of the core back; and a plurality of teeth parts including a winding part adhered to the plurality of buffer members to protrude in an outer diameter direction of the core back and having a coil wound therearound and a stopper preventing the coil from being separated.

The buffer member may be an epoxy adhesive containing an epoxy resin.

The core back may include a plurality of filling grooves in the outer peripheral surface thereof, and the plurality of buffer members may be disposed in the plurality of filling grooves.

The stator core may further include an outer core provided to correspond to a form in which the core back and the plurality of teeth parts are coupled to each other, and stacked on at least one of upper and lower surfaces of the core back and the teeth parts.

A pair of outer cores may be provided to be stacked on the upper and lower surfaces of the core back and the teeth parts, respectively.

The core back may include a plurality of first coupling grooves in a surface on which the outer core is stacked, and the outer core may include a plurality of first coupling protrusions inserted into the plurality of first coupling grooves, respectively.

The first coupling protrusion may be formed in a caulking process.

The plurality of teeth parts may include second coupling grooves in a surface on which the outer core is stacked, respectively, and the outer core may include a plurality of second coupling protrusions inserted into the second coupling grooves, respectively.

The second coupling protrusion may be formed in a caulking process.

The outer core may be formed of a stainless steel sheet material.

The core back and the teeth part may be formed by stacking a plurality of steel sheets.

The steel sheet may be a silicon steel sheet.

According to another aspect of the present disclosure, a spindle motor may include: a fixed member to which the stator core as described above, including a coil wound therearound is coupled; and a rotating member rotatably supported with respect to the fixed member and including a magnet disposed therein, wherein the magnet generates rotational driving force through electromagnetic interaction with the coil.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic cross-sectional view of a spindle motor according to the related art;

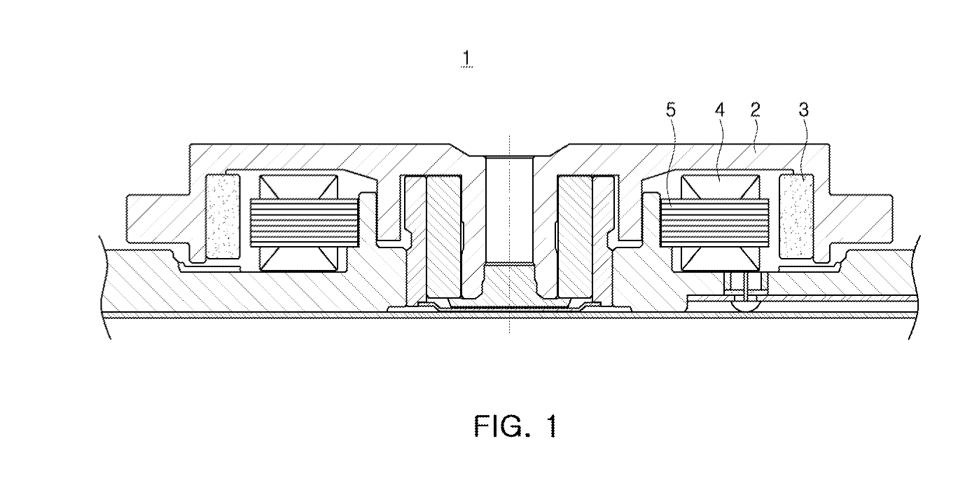

FIG. 2 is a plan view of a stator core provided in the spindle motor according to the related art;

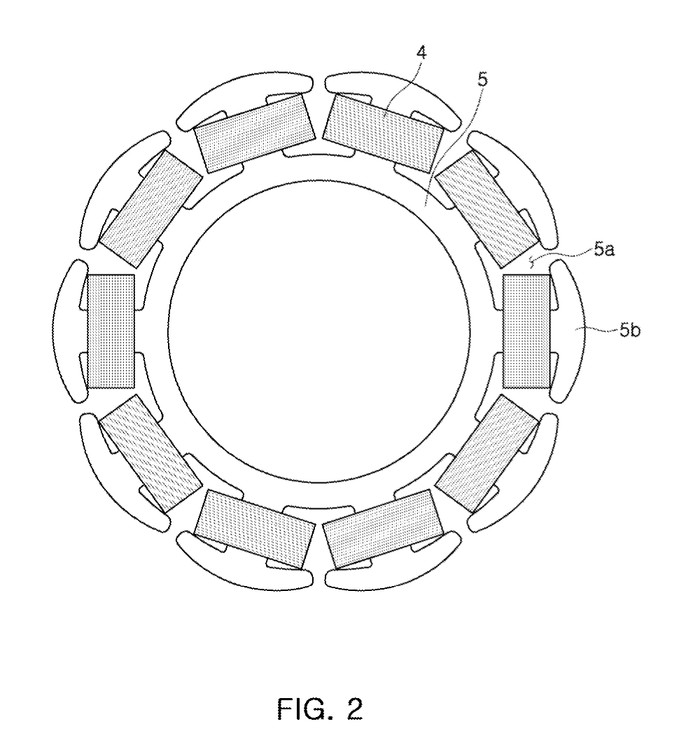

FIG. 3 is a schematic cross-sectional view of a spindle a motor including a stator core according to an exemplary embodiment of the present disclosure;

FIG. 4 is a perspective view of the stator core according to an exemplary embodiment of the present disclosure;

FIG. 5 is an exploded perspective view of the stator core according to an exemplary embodiment of the present disclosure;

FIG. 6 is a cross-sectional view taken along line A-A′ of FIG. 4; and

FIG. 7 is a cross-sectional view taken along line B-B′ of FIG. 4.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

Hereinafter, a spindle motor 10 including a stator core according to an exemplary embodiment of the present disclosure will be first described, and exemplary embodiments of the stator core 100 will be described.

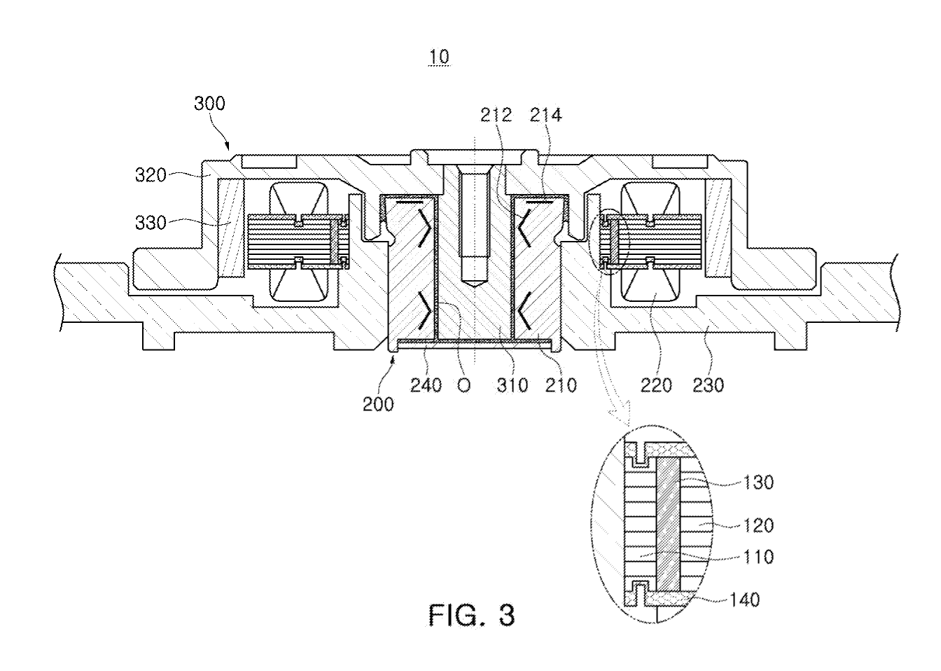

FIG. 3 is a schematic cross-sectional view of the spindle motor 10 including the stator core 100 according to an exemplary embodiment of the present disclosure.

Referring to FIG. 3, the spindle motor 10 according to an exemplary embodiment of the present disclosure may include a fixed member 200 coupled to the stator core 100 and a rotating member 300 rotatably supported with respect to the fixed member 200.

Terms with respect to directions will be first defined. As viewed in FIG. 3, an axial direction refers to a vertical direction based on a shaft 310, and an outer diameter or inner diameter direction refers to a direction towards an outer edge of a hub 320 based on the shaft 310 or a direction towards the center of the shaft 310 based on the outer edge of the hub 320.

In addition, a circumferential direction refers to a direction in which the shaft 310 rotates along an outer peripheral surface thereof.

The fixed member 200 refers to all components except for the rotating member 300 in the spindle motor 10, according to an exemplary embodiment of the present disclosure. More specifically, the fixed member 200 may include a sleeve 210 supporting the shaft 310, the stator core 100 having a coil 230 wound therearound, and a base 220.

The sleeve 210, a component supporting the shaft 310, a component of the rotating member 300, may support the shaft 310 so that an upper end of the shaft 310 protrudes upwardly in the axial direction, and may be formed by forging copper (Cu) or aluminum (Al) or sintering Cu—Fe based alloy powder or SUS based powder.

In addition, the sleeve 210 may include a shaft hole having the shaft 310 inserted thereinto to form a micro clearance therebetween, wherein the micro clearance is filled with oil O, such that the shaft 310 may be stably supported by radial dynamic pressure generated in the oil O.

In addition, radial dynamic pressure may be generated in the oil O by a fluid dynamic pressure part 212 formed as a groove in an inner peripheral surface of the sleeve 210. The fluid dynamic pressure part 212 may have one of a herringbone pattern, a spiral pattern, a helix pattern.

However, the fluid dynamic pressure part 212 is not limited to being formed in the inner peripheral surface of the sleeve 210 as described above and may also be formed in an outer peripheral surface of the shaft 310, the rotating member 300. In addition, the number of fluid dynamic pressure parts 212 is also not limited.

In addition, the sleeve 210 may include a thrust dynamic pressure part 214 formed in an upper surface thereof to generate thrust dynamic pressure in the oil O. The rotating member 300 including the shaft 310 may rotate in a state in which a predetermined degree of floating force is secured by the thrust dynamic pressure part 214.

Here, the thrust dynamic pressure part 214 may be a groove having a herringbone pattern, a spiral pattern, or a helix pattern, similar to the fluid dynamic pressure part 212. However, the thrust dynamic pressure part 214 is not necessarily limited to having the above-mentioned shape, but may have any shape as long as thrust dynamic pressure may be provided.

In addition, the thrust dynamic pressure part 214 is not limited to being formed in the upper surface of the sleeve 210, but may also be formed in one surface of the hub 320 corresponding to the upper surface of the sleeve 210.

Further, the sleeve 210 may include a base cover 240 coupled to a lower portion thereof to close the lower portion thereof. The spindle motor 10 according to an exemplary embodiment of the present disclosure may be formed in a full-fill structure by the base cover 240.

The rotating member 300 may include the shaft 310 and the hub 320 including a magnet 330, and include all components that rotate while being supported by the fixed member 200.

First, the shaft 310 may be inserted into the shaft hole of the sleeve 210 to have the micro clearance therebetween to thereby rotate in the sleeve 210, and may include the hub 320 coupled to an upper portion thereof.

The hub 320 may be a rotating structure rotatably provided with respect to the fixed member 200 including the base 220 and include an annular ring-shaped magnet 330 provided on an inner peripheral surface thereof, wherein the annular ring-shaped magnet 330 corresponds to the stator core 100 having the coil 230 wound therearound, having a predetermined interval therebetween.

Therefore, when external power is applied to the coil 230, the rotating member 300 may be rotated by rotational driving force caused by electromagnetic interaction between the coil 230 and the magnet 330 provided in the hub 320.

Hereinafter, the stator core 100 according to an exemplary embodiment of the present disclosure will be described in detail.

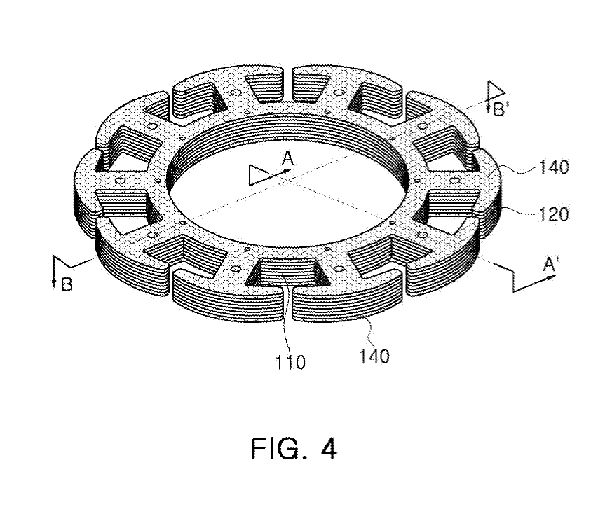

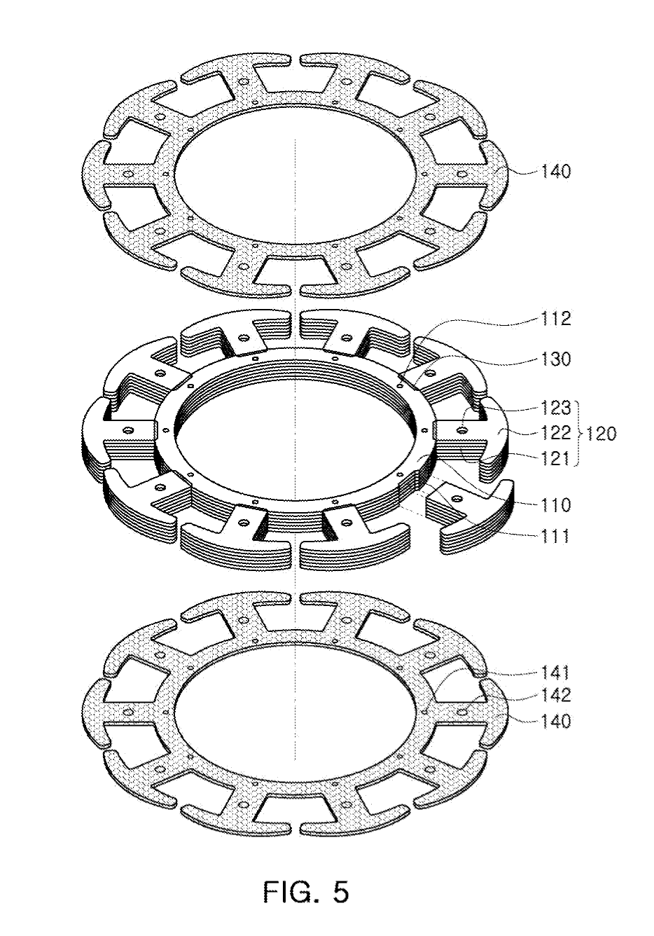

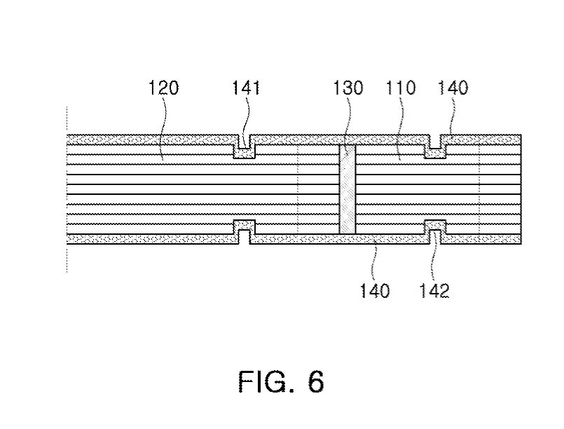

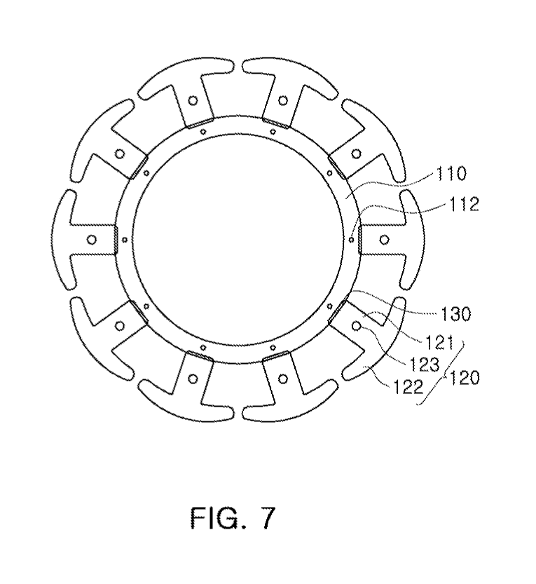

FIG. 4 is a perspective view of the stator core 100 according to an exemplary embodiment of the present disclosure, FIG. 5 is an exploded perspective view of the stator core 100 according to an exemplary embodiment of the present disclosure, FIG. 6 is a cross-sectional view taken along line A-A′ of FIG. 4; and FIG. 7 is a cross-sectional view taken along line B-B′ of FIG. 4.

Referring to FIGS. 4 through 7, the stator core 100 according to an exemplary embodiment of the present disclosure may include a core back 110 having a ring shape, a teeth part 120 protruding in an outer diameter direction of the core back 110, a buffer member 130 provided at an outer peripheral surface of the core back 110 to adhere the core back 110 and the teeth part 120 to each other, and an outer core 140.

An opening into which the base 220, a corresponding component, is inserted and fixed may be formed in the core back 110, and the opening may be disposed, for example, in the center of the core back 110.

In addition, although the core back 110 may have an annular ring shape as shown in FIGS. 4 and 5, the shape of the core back 110 and a position of the opening are not limited thereto, but may be variously deformed.

That is, the core back 110 may have various shapes such as a tetragonal ring shape, a hexagonal ring shape, an octagonal ring shape, and the like, according to a portion of the base 220 to be inserted.

Here, the core back 110 may be formed by stacking a plurality of steel sheets that are each pressed as a single sheet, wherein the steel sheet may be a silicon steel sheet.

Meanwhile, the outer peripheral surface of the core back 110 may be provided with a plurality of filling grooves 111 depressed in the inner diameter direction. In this case, a buffer member 130 to be described below may be disposed in the plurality of filling grooves 111.

On the other hand, a first coupling groove 112 into which a first coupling protrusion 141 of the outer core 140 to be described below is inserted may be provided in at least one of upper and lower surfaces of the core back 110.

A plurality of buffer members 130 may be adhered along the outer peripheral surface of the core back 110. In more detail, the buffer member 130 may be filled in the filling groove 111.

Here, the buffer member 130 may be an adhesive adhering the teeth part 120 along the outer peripheral surface of the core back 110. For example, the buffer member 130 may be an epoxy adhesive containing an epoxy resin. In other words, the teeth part 120 may be adhered to the outer peripheral surface of the core back 110 through the buffer member 130.

Meanwhile, vibrations and noise are generated due to a discontinuous magnetic field formed by application of a current to the coil 230 wound around the teeth part 120, but the buffer member 130 may decrease vibrations and noise.

More specifically, when the rotating member 300 rotates, vibrations, that is, shaking, may be generated in the teeth part 120 due to discontinuity of the magnetic field, but the buffer member 130 may serve as a damper, such that vibrations transferred to the core back 110 may be decreased. Therefore, vibrations and noise generated in the spindle motor 10 may be decreased.

The teeth part 120 may include a winding part 121 having the coil 230 wound therearound and a stopper 122 preventing the coil 230 from being separated. One end of the winding part 121 may be adhered to the buffer member 130. In other words, one end of the winding part 121 is adhered to the buffer member 130, such that the teeth part 120 may be provided to protrude in the outer diameter direction of the core back 110.

Here, the stopper 122 may define an outer edge of the stator core 100 according to an exemplary embodiment of the present disclosure in a radial direction and has a rounded outer side surface so that the stator core 100 has an entirely circular shape.

Meanwhile, the teeth part 120 may be formed by stacking a plurality of steel sheets that are each pressed as a single sheet, similarly to the core back 110, wherein the steel sheet may be a silicon steel sheet.

On the other hand, a second coupling groove 123 into which a second coupling protrusion 142 of the outer core 140 to be described below is inserted may be provided in at least one of upper and lower surfaces of the teeth part 120.

The outer core 140 may be provided to correspond to a shape in which the core back 110 and the plurality of teeth parts 120 are coupled to each other. That is, the outer core 140 may have the same plan outline as the shape in which the core back 110 and the plurality of teeth parts 120 are coupled to each other.

Here, the outer core 140 may be stacked on at least one of the upper and lower surfaces of the core back 110 and the plurality of teeth parts 120. Preferably, a pair of outer cores 140 may be provided to be stacked on the upper and lower surfaces of the core back 110 and the plurality of teeth parts 120, respectively.

Therefore, a problem in strength of the stator core 100 that will be generated by coupling the core back 110 and the plurality of teeth parts 120 to each other using the buffer member 130 may be solved.

Meanwhile, the outer core 140 may include a plurality of first coupling protrusion 141 inserted into a plurality of first coupling grooves 112. In this case, the first coupling protrusion 141 may be formed in a caulking process. In other words, after closely adhering the outer core 140 to the upper surface and/or lower surface of the core back 110, the first coupling protrusion 141 may be inserted into the first coupling groove 112 simultaneously with being formed by the caulking process. Therefore, coupling force between the outer core 140 and the core back 110 may be further increased.

In addition, the outer core 140 may include the second coupling protrusion 142 inserted into the second coupling grooves 132 provided in the plurality of teeth parts 120. In this case, the second coupling protrusion 142 may also be formed by the caulking process. That is, after closely adhering the outer core 140 to the upper surface and/or lower surface of the teeth part 120, the second coupling protrusion 142 may be inserted into the second coupling groove 123 simultaneously with being formed by the caulking process. Therefore, coupling force between the outer core 140 and the teeth part 120 may be further increased.

Here, the first and second coupling protrusions 141 and 142 may be simultaneously formed. That is, the outer core 140 may be stacked on and coupled to the upper surfaces and/or lower surfaces of the core back 110 and the teeth part 120 by a single caulking process.

Meanwhile, the outer core 140 may be formed of a stainless steel sheet material.

As described above, the stator core 100 according to an exemplary embodiment of the present disclosure includes the buffer member 130 capable of performing a damping function between the core back 110 and the teeth part 120, such that vibrations and noise generated at the time of operation of the spindle motor 10 may be decreased.

As set forth above, with the stator core and the spindle motor including the same according to exemplary embodiments of the present disclosure, vibrations and noise generated at the time of rotation may be decreased.

While exemplary embodiments have been shown and described above, it will be apparent to those skilled in the art that modifications and variations could be made without departing from the scope of the present invention as defined by the appended claims.

What is claimed is:

1. A stator core comprising:
a core back having a ring shape;
a plurality of buffer members adhered to an outer peripheral surface of the core back; and
a plurality of teeth parts including a winding part adhered to the plurality of buffer members to protrude in an outer diameter direction of the core back and having a coil wound therearound and a stopper preventing the coil from being separated.

2. The stator core of claim 1, wherein the buffer member is an epoxy adhesive containing an epoxy resin.

3. The stator core of claim 1, wherein the core back includes a plurality of filling grooves in the outer peripheral surface thereof, and
the plurality of buffer members are disposed in the plurality of filling grooves.

4. The stator core of claim 1, further comprising an outer core provided to correspond to a form in which the core back and the plurality of teeth parts are coupled to each other, and stacked on at least one of upper and lower surfaces of the core back and the teeth parts.

5. The stator core of claim 4, wherein a pair of outer cores is provided to be stacked on the upper and lower surfaces of the core back and the teeth parts, respectively.

6. The stator core of claim 4, wherein the core back includes a plurality of first coupling grooves in a surface on which the outer core is stacked, and
the outer core includes a plurality of first coupling protrusions inserted into the plurality of first coupling grooves, respectively.

7. The stator core of claim 6, wherein the first coupling protrusion is formed in a caulking process.

8. The stator core of claim 4, wherein the plurality of teeth parts include second coupling grooves in a surface on which the outer core is stacked, respectively, and
the outer core includes a plurality of second coupling protrusions inserted into the second coupling grooves, respectively.

9. The stator core of claim 8, wherein the second coupling protrusion is formed in a caulking process.

10. The stator core of claim 4, wherein the outer core is formed of a stainless steel sheet material.

11. The stator core of claim 1, wherein the core back and the teeth part are formed by stacking a plurality of steel sheets.

12. The stator core of claim 11, wherein the steel sheet is a silicon steel sheet.

13. A spindle motor comprising:
a fixed member to which a stator core including a coil wound therearound is coupled; and
a rotating member rotatably supported with respect to the fixed member and including a magnet disposed therein, the magnet generating rotational driving force through electromagnetic interaction with the coil,
wherein the stator core includes a core back having a ring shape; a plurality of buffer members adhered to an outer peripheral surface of the core back; and a plurality of teeth parts including a winding part adhered to the plurality of buffer members to protrude in an outer diameter direction of the core back and having a coil wound therearound and a stopper preventing the coil from being separated.
